(19) United States
(12) Patent Application Publication
(10) Pub. No.: US 2022/0215237 A1
(43) Pub. Date: Jul. 7, 2022

(54) OPERATION DEVICE AND OPERATION ALLOCATION METHOD

(71) Applicant: NEC corporation, Minato-ku, Tokyo (JP)

(72) Inventors: Takashi TAKENAKA, Tokyo (JP); Fumiyo TAKANO, Tokyo (JP); Seiya SHIBATA, Tokyo (JP); Hiroaki INOUE, Tokyo (JP)

(73) Assignee: NEC corporation, Minato-ku, Tokyo (JP)

(21) Appl. No.: 17/607,540

(22) PCT Filed: May 8, 2019
(86) PCT No.: PCT/JP2019/018429

§ 371 Date: Oct. 29, 2021

(51) Int. Cl. G06N 3/063; G06N 3/08

(52) U.S. Cl. CPC G06N 3/063; G06N 3/08

(57) ABSTRACT

Each chip 70 includes weight storage unit for storing weights for each edge determined by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between the channels belonging to corresponding groups, an edge is set between the channels belonging to non-corresponding groups under a restriction. The weight storage unit stores the weights determined for the edge between the channels, each of which corresponds to each chip including the weight storage unit, belonging to corresponding groups.

### TECHNICAL FIELD

The present invention relates to an operation device comprising a plurality of chips, and an operation allocation method of allocating operations to the plurality of chips.

### BACKGROUND ART

Patent literatures 1 and 2 describe circuits, etc. that perform parallel processing.

In addition, non-patent literature 1 describes a device that processes one frame and the next frame in a video with different circuits.

Non-patent literature 2 describes a device that performs the processing of the first through nth layer of a neural network, and the processing of the (n+1)th and subsequent layers with different circuits.

In addition, grouped convolution is described in non-patent literature 3.

Non-Patent literature 4 describes a technique to set a weight in a neural network to zero.

Non-patent literature 5 describes a technique to reduce a weight in a neural network.

### CITATION LIST

### Patent Literatures

PTL 1: Japanese Patent Application Laid-Open No. 2018-67154
PTL 2: Japanese Patent Application Laid-Open No. 2018-55570 Non-patent Literatures
NPL 1: Weishan Zhang et al., “Distributed Embedded Deep Learning based Real-Time Video Processing”, 2016 IEEE International Conference on Systems, Man, and Cybernetics, SMC 2016, October, 2016
NPL 2: Jong Hwan Ko, Taesik Na, Mohammad Faisal Amir, Saibal Mukhopadhyay, “Edge-Host Partitioning of Deep Neural Networks with Feature Space Encoding for Resource-Constrained Internet-of-Things Platforms”, [online], [retrieved Oct. 2, 2018], Internet <URL: https://arxiv.org/pdf/1802.03835.pdf>
NPL 3: “Technical Memorandum Collection,” [online], Dec. 29, 2017, [retrieved Oct. 2, 2018], Internet <URL: https://www.robotech-note.com/entry/2017/12/29/084349>
NPL 4: Song Han et al., “Learning Both Weights and Connections for Efficient Neural Networks”, [online], [retrieved 5 Feb. 2019], Internet<URL: https://arxiv.org/pdf/1506.02626.pdf>
NPL 5: Guodong Zhang et al., “THREE MECHANISMS OF WEIGHT DECAY REGULARIZATION”, [online], [retrieved 11 Apr. 2019], Internet <URL: https://arxiv.org/pdf/1810.12281.pdf>

### SUMMARY OF THE INVENTION

### Technical Problem

In recent years, operations of a neural network have become increasingly large-scale. This makes it difficult to perform high-speed operations when operations of a neural network are performed on a single chip.

On the other hand, it is possible to perform neural network operations on multiple chips. In such a case, if the amount of data communication between chips increases, it becomes difficult to perform high-speed operations.

Therefore, it is an object of the present invention to provide an operation device and an operation allocation method that can reduce the amount of data communication between chips while performing neural network operations on multiple chips.

### Solution to Problem

An operation device according to the present invention includes a plurality of chips, wherein each chip comprises weight storage means for storing weights for each edge determined by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between the channels belonging to corresponding groups, an edge is set between the channels belonging to non-corresponding groups under a restriction, wherein the weight storage means in each chip stores the weights determined for the edge between the channels, each of which corresponds to each chip including the weight storage means, belonging to corresponding groups, and wherein each chip further includes operation means for calculating a set of values for the channel that belongs to the group in the first layer corresponding to the group in the 0th layer, based on the weight stored in the weight storage means in the chip, and a set of values for the channel that belongs to the group in the 0th layer corresponding to the chip.

An operation device according to the present invention includes a plurality of chips, wherein each chip comprises weight storage means for storing weights for each edge determined by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between each channel in the first layer and each channel in the 0th layer, the weight between the channels that belong to non-corresponding groups is learned so that the weight becomes to be 0 or close to 0 as possible, wherein the weight storage means in each chip stores a first weight determined for the edge between the channels, each of which corresponds to each chip including the weight storage means, belonging to corresponding groups, and a second weight for the edge between the channel, belonging to the group in the first layer, corresponding to the chip and the channel, belonging to the group in the 0th layer, non-corresponding to the chip, wherein the second weight is equal to or more than a predetermined threshold, and wherein each chip further includes operation means for calculating a set of values for the channel that belongs to the group in the first layer corresponding to the group in the 0th layer, based on the first weight and a set of values for the channel that belongs to the group in the 0th layer corresponding to the chip, and when calculating the set of values for the channel that belongs to the group corresponding to the chip in the first layer, if there is the channel belonging to the group that does not correspond to the group corresponding to the chip and for which the edge connected to the channel belonging to the group corresponding to the chip is set wherein the second weight is determined for the edge, obtaining the set of values for the channel belonging to the group that does not correspond to the group corresponding to the chip from another chip that corresponds to the group that does not correspond to the group corresponding to the chip, and calculating the set of values for the channel that belongs to the group corresponding to the chip in the first layer using obtained set of values and the second weight.

An operation method according to the present invention is a method for allocating operations to a plurality of chips included in an operation device, including determining weights for each edge by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between the channels belonging to corresponding groups, an edge is set between the channels belonging to non-corresponding groups under a restriction, and allocating the weight determined for the edge between the channels, each of which corresponds to each chip, belonging to corresponding groups, to each chip, wherein a set of values for the channel that belongs to the group in the first layer corresponding to the group in the 0th layer is calculated by each chip, based on the weight allocated to the chip, and a set of values for the channel that belongs to the group in the 0th layer corresponding to the chip.

An operation method according to the present invention is a method for allocating operations to a plurality of chips included in an operation device, including determining weights for each edge by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between each channel in the first layer and each channel in the 0th layer, the weight between the channels that belong to non-corresponding groups is learned so that the weight becomes to be 0 or close to 0 as possible, removing the edge whose weight is less than a predetermined threshold, and allocating to each chip a first weight determined for the edge between the channels, each of which corresponds to each chip, belonging to corresponding groups, and a second weight determined for the edge between the channel, belonging to the group in the first layer, corresponding to the chip and the channel, belonging to the group in the 0th layer, non-corresponding to the chip, wherein the second weight is equal to or more than a predetermined threshold, wherein in each chip, a set of values for the channel that belongs to the group in the first layer corresponding to the group in the 0th layer is calculated, based on the first weight allocated to the chip and a set of values for the channel that belongs to the group in the 0th layer corresponding to the chip, and when calculating the set of values for the channel that belongs to the group corresponding to the chip in the first layer, if there is the channel belonging to the group that does not correspond to the group corresponding to the chip and for which the edge connected to the channel belonging to the group corresponding to the chip is set, the set of values for the channel belonging to the group that does not correspond to the group corresponding to the chip is obtained from another chip that corresponds to the group that does not correspond to the group corresponding to the chip, and the set of values for the channel that belongs to the group corresponding to the chip in the first layer is calculated using obtained set of values and the second weight.

### Advantageous Effects of Invention

According to this invention, it is possible to reduce amount of data communication between chips while performing neural network operations on multiple chips.

### BRIEF DESCRIPTION OF DRAWINGS

FIG. 1 It depicts a schematic diagram showing an example of multiple channels in L0 and L1 layers.

FIG. 2 It depicts a schematic diagram showing values used to calculate each feature value group in the L1 layer.

FIG. 3 It depicts a schematic diagram showing an example of a case where channels are divided into groups on condition that the number of the groups of the L0 layer is the same as it of the L1 layer.

FIG. 4 It depicts a schematic diagram showing values used to calculate each feature value group in the L1 layer in the example shown in FIG. 3.

FIG. 5 It depicts a schematic diagram showing an example of an edge in the case where the restriction of setting an edge only for some pairs of channels out of pairs belonging to non-corresponding groups is adopted.

FIG. 6 It depicts a schematic diagram showing values used to calculate each feature value group in the L1 layer in the example shown in FIG. 5.

FIG. 7 It depicts a block diagram showing an exemplary configuration of the operation device of the present invention.

FIG. 8 It depicts a flowchart shows an example of a process from learning the weights to a calculation process.

FIG. 9 It depicts a schematic diagram showing an example of a case where channels are divided into groups on condition that the number of the groups of the L0 layer is the same as it of the L1 layer in the second example embodiment.

FIG. 10 It depicts a block diagram showing an overview of the operation device of the present invention.

### DESCRIPTION OF EMBODIMENTS

Before explaining the example embodiment of the present invention, an operation of a neural network is explained. In the operation of a neural network, when calculating values in a layer, the values calculated in the previous layer are used. Such calculation of values is performed sequentially for each layer. In the following explanation, the layer for which values are to be calculated and the previous layer are focused on. The layer where the values are to be calculated is called the L1 layer, and the layer before the L1 layer is called the L0 layer, where the values have already been calculated.

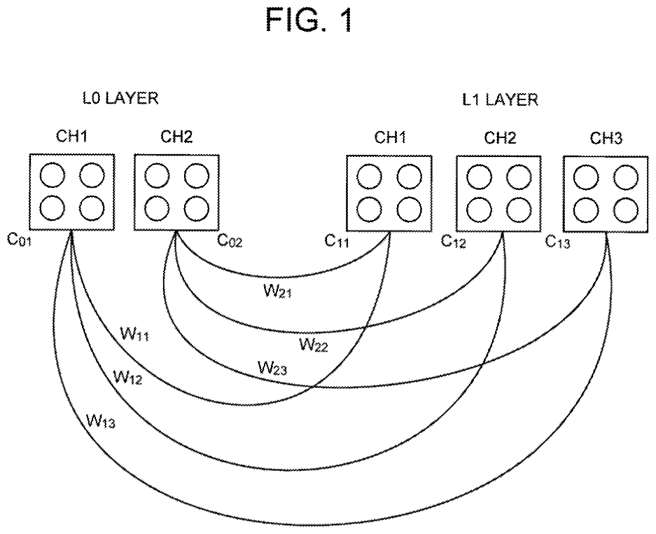

Each layer contains a plurality of channels. The L0 and L1 layers also contain a plurality of channels, respectively. FIG. 1 is a schematic diagram showing an example of multiple channels in the L0 and L1 layers.

In the example shown in FIG. 1, the L0 layer includes two channels CH1 and CH2. In addition, the L1 layer contains three channels CH1 to CH3. However, the number of channels in each layer is not limited to the example shown in FIG. 1.

The individual circles in FIG. 1 indicate values. The values in the L1 layer are values that are about to be calculated. It is assumed that the values have already been calculated for each channel in the L0 layer.

The set of values for each channel is referred to as the feature value group.

In the example shown in FIG. 1, in the L0 layer, the feature value group corresponding to channel CH1 is written as C₀₁, and the feature value group corresponding to channel CH2 is written as C₀₂. Similarly, in the L1 layer, the feature value group corresponding to channel CH1 is written as C₁₁, the feature value group corresponding to channel CH2 is written as C₁₂, and the feature value group corresponding to channel CH3 is written as C₁₃.

In order to calculate sets of feature values in the L1 layer, weights are determined by learning to the connections between the channels in the L1 layer and the channels in the L0 layer.

The connection between the channels for which weights are determined is called edge. In the example shown in FIG. 1, an edge is defined between each channel in the L0 layer and each channel in the L1 layer. The number of edges in this example is six. In the example shown in FIG. 1, the weights defined for each of the six edges are W₁₁, W₁₂, W₁₃, W₂₁, W₂₂, and W₂₃.

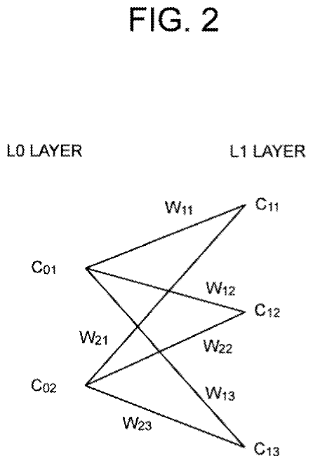

Each feature value group of the L1 layer is calculated by the weights and the feature value group of the L0 layer. FIG. 2 shows a schematic diagram of the values used to calculate each feature value group in the L1 layer.

The feature value group C₁₁ corresponding to the channel CH1 of the L1 layer is calculated using the feature value group C₀₁, the weight W₁₁, the feature value group C₀₂, and the weight W₂₁ (refer to FIG. 1 and FIG. 2).

Similarly, the feature value group C₁₂ corresponding to the channel CH2 of the L1 layer is calculated using the feature value group C₀₁, the weight W₁₂, the feature value group C₀₂, and the weight W₂₂ (refer to FIG. 1 and FIG. 2).

Similarly, the feature value group C₁₃ corresponding to the channel CH3 of the L1 layer is calculated using the feature value group C₀₁, the weight W₁₃, the feature value group C₀₂, and the weight W₂₃ (refer to FIGS. 1 and 2).

Hereinafter, example embodiments of the present invention are described with reference to the drawings.

### Example Embodiment 1

In each of the aforementioned L0 and L1 layers, the channels shall be divided into the same number of groups. This number of groups is the number of chips included in the operation device of the present invention. That is, in each of the L0 and L1 layers, the channels are divided into the same number of groups as it of the chips. The number of chips is an integer greater than or equal to two. For the sake of simplicity, the case where the number of chips is two will be used as an example.

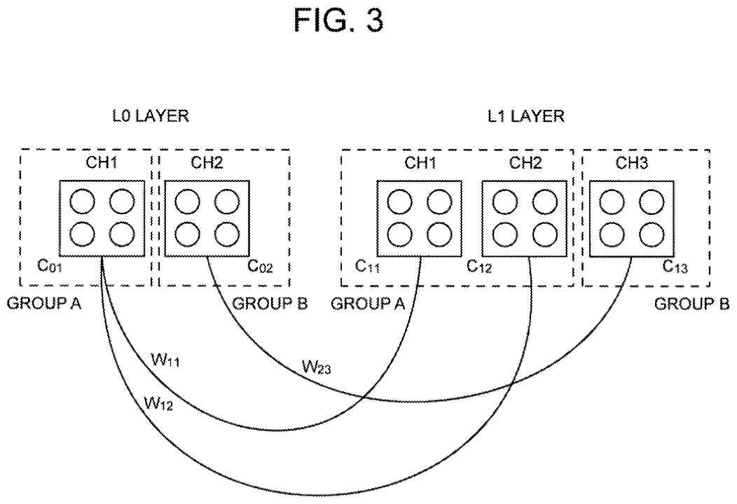

FIG. 3 is a schematic diagram showing an example of a case where channels are divided into groups on condition that the number of the groups of the L0 layer is the same as it of the L1 layer. Matters similar to those in FIG. 1 are indicated with the same sign as in FIG. 1, and detailed explanations are omitted. In this example, since the number of chips is two, the channels in the L0 layer are divided into two groups, and the channels in the L1 layer are also divided into two groups. The number of channels belonging to one group may be 0 or 1. In FIG. 3, groups of channels are represented by dashed rectangles. In the example shown in FIG. 3, the channels in the L0 layer are divided into a group including CH1 (the group A in the L0 layer) and a group including CH2 (the group B in the L0 layer). The channels in the L1 layer are divided into a group including CH1 and CH2 (the group Ain the L1 layer) and a group including CH3 (the group B in the L1 layer).

The number of groups of channels in the L0 layer and the number of groups of channels in the L1 layer are the same. In addition, the number of groups of channels in each layer is the same as the number of chips. Therefore, the groups of channels in the L0 layer and the groups of channels in the L1 layer can be mapped one-to-one. In this example, it is assumed that the group A of each layer is mapped to each other and the group B of each layer is mapped to each other. It is also assumed that one of the two chips is mapped to the group A and the other to the group B.

When the channels are divided into the same number of pairs in each of the L0 and L1 layers, edges are set between the channels belonging to the corresponding groups. In this example, since the group A corresponds to each other, an edge is set between CH1 of the L0 layer and CH1 of the L1 layer, and between CH1 of the L0 layer and CH2 of the L1 layer, respectively. Similarly, since the group B corresponds to each other, an edge is set between the channel CH2 of the L0 layer and the channel CH3 of the L1 layer.

In this example embodiment, there is a restriction on setting edges between channels that belong to non-corresponding groups. One example of the restriction is that no edge is set between channels that belong to non-corresponding groups. Another example is the restriction that edges are set only for some pairs of channels that belong to non-corresponding groups.

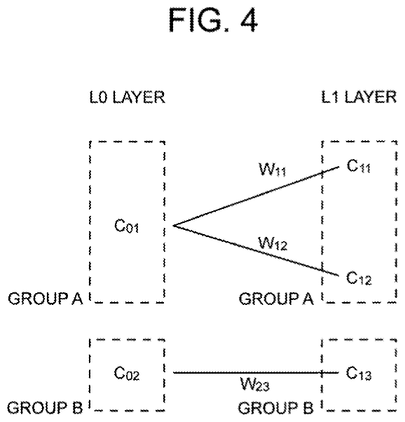

FIG. 3 and FIG. 4 below illustrate the case where the restriction of setting no edges between channels belonging to non-corresponding groups is adopted. Under the condition that such a restriction is set, weights are determined by learning only for the edges that are set.

FIG. 4 shows a schematic diagram of the values used to calculate each feature value group for the L1 layer in the example shown in FIG. 3.

The feature value group C₁₁ corresponding to the channel CH1 of the L1 layer is calculated using the feature value group C₀₁ and the weight W₁₁ (refer to FIG. 3 and FIG. 4). Similarly, the feature value group C₁₂ corresponding to the channel CH2 of the L1 layer is calculated using the feature value group C₀₁ and the weight W₁₂ (refer to FIG. 3 and FIG. 4).

The feature value group C₁₃ corresponding to the channel CH3 of the L1 layer is calculated using the feature value group C₀₂ and the weights W₂₃ (refer to FIG. 3 and FIG. 4).

In the case of the examples shown in FIGS. 3 and 4, the operation device of the present invention performs an operation of calculating the feature value groups C₁₁ and C₁₂ on the chip corresponding to the group A, and an operation of calculating the feature value group C₁₃ on the chip corresponding to the group B. Therefore, there is no need for data communication between chips when calculating each feature value group C₁₁, C₁₂ and C₁₃ of the L1 layer. Accordingly, the amount of data communication between chips can be reduced.

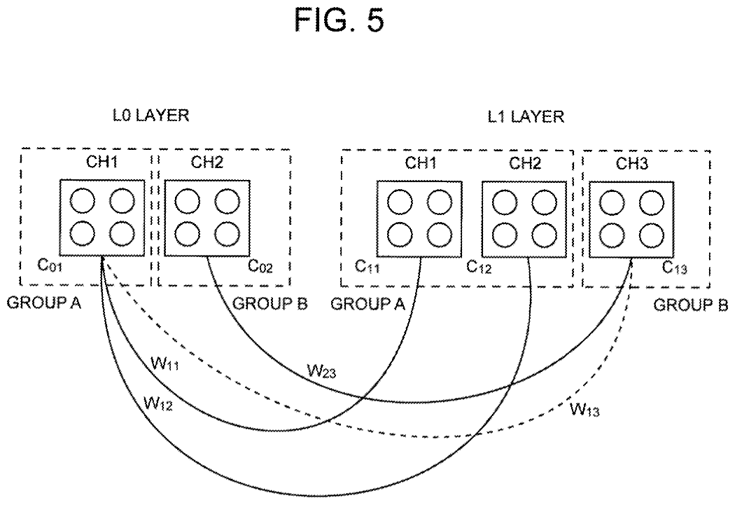

Next, an example of the case, where the restriction that edges are set only for some pairs of channels that belong to non-corresponding groups is adopted, will be shown. FIG. 5 shows an example of edges in the case where this restriction is adopted. Matters similar to those in FIG. 3 are indicated with the same sign as in FIG. 3, and detailed explanations are omitted. An edge between channels belonging to non-corresponding groups is indicated by a dashed line.

In the example shown in FIG. 5, there are a pair of CH1 in the L0 layer and CH3 in the L1 layer, a pair of CH2 in the L0 layer and CH1 in the L1 layer, and a pair of CH2 in the L0 layer and CH2 in the L1 layer as pairs of channels that belong to non-corresponding groups. In other words, in the example shown in FIG. 5, there are three pairs of channels that belong to non-corresponding groups. When the restriction that edges are set only for some of the pairs of channels belonging to the non-corresponding groups is adopted, edges are set only for some of these three pairs (in this example, one or two pairs). In FIG. 5, the case where an edge is set for the pair of CH1 in the L0 layer and CH3 in the L1 layer is illustrated. In addition, the weight learned for this edge is W₁₃.

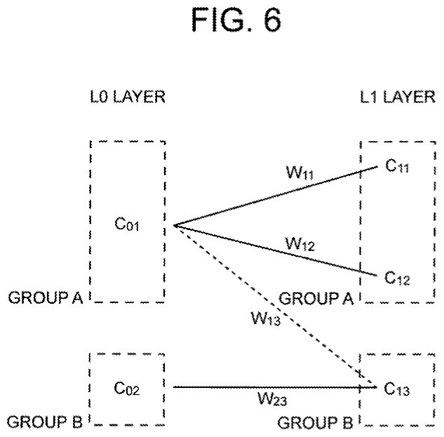

FIG. 6 is a schematic diagram showing the values used to calculate each feature value group of the L1 layer in the example shown in FIG. 5. The feature value groups C₁₁ and C₁₂ are the same as those shown in FIG. 4 and are omitted from the explanation. In this example, the feature value group C₁₃ corresponding to the channel CH3 of the L1 layer is calculated using the feature value group C₀₂, the weight W₂₃, the feature value group C₀₁ and the weight W₁₃ (refer to FIGS. 5 and 6).

In the case of the examples shown in FIGS. 5 and 6, the operation device of the present invention performs the calculation of the feature value groups C₁₁ and C₁₂ on the chip corresponding to the group A, and the calculation of the feature value group C₁₃ on the chip corresponding to the group B. In this case, no data communication between the chips is required for the calculation of the feature value groups Cn and C₁₂. To calculate the feature value group C₁₃, the data of the feature value group C₀₁ is transmitted from the chip corresponding to the group A to the chip corresponding to the group B. Therefore, data communication occurs, but the amount of data communication is less than when edges are set for all pairs of channels that belong to non-corresponding groups. Accordingly, in this example as well, the amount of data communication between chips can be reduced.

The edge weights may be determined in the same way for each connection between adjacent layers. This is also the case in the second example embodiment described below.

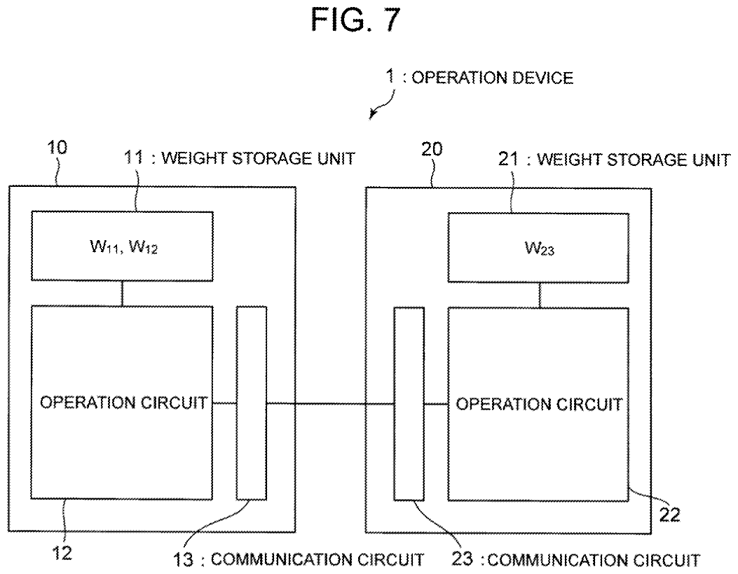

FIG. 7 is a block diagram of an example configuration of the operation device of the present invention. The operation device of the present invention comprises a plurality of chips. As mentioned above, for the sake of simplicity of explanation, the case where the number of chips is two will be used as an example. Therefore, FIG. 7 also illustrates the case where the operation device 1 comprises two chips 10, 20. However, the operation device 1 may comprise three or more chips.

In the following explanation, the case of calculating the feature value group of the L1 layer from the feature value group of the L0 layer will be used as an example. It is preferable that the calculation method regarding the connection between other layers is the same as the calculation method for calculating the feature value group of the L1 layer from the feature value group of the L0 layer. However, the calculation method regarding the connection between other layers may be different from the calculation method for calculating the feature value group of the L1 layer from the feature value group of the L0 layer. In the present invention, it is sufficient that the calculation method for calculating the feature value group of the L1 layer from the feature value group of the L0 layer is applied between at least one group of adjacent layers in the neural network.

The chip 10 comprises a weight storage unit 11, an operation circuit 12 and a communication circuit 13.

Similarly, the chip 20 comprises a weight storage unit 21, an operation circuit 22 and a communication circuit 23.

The weight storage units 11, 21 is realized by a memory in the chip. The operation circuits 12, 22 are realized by a processor in the chip. The communication circuits 13, 23 are realized by a communication interface for inter-chip communication.

The weight storage unit 11 and the weight storage unit 21 store the weights determined for each edge by learning. In FIG. 7, it is illustrated that the weight storage unit 11 stores weights W₁₁ and W₁₂ (refer to FIG. 3 and FIG. 4), and the weight storage unit 21 stores weight W₂₃ (refer to FIG. 3 and FIG. 4).

Here, the learning of the weights stored in the weight storage units 11, 21 in the respective chips 10, 20 will be explained.

Before learning the weights, the channels in the L0 layer and the channels in the L1 layer are divided into the same number of groups as the number of chips. Further, the groups of channels in the L0 layer and the groups of channels in the L1 layer are associated with the chips without omission and without overlap. The grouping of the channels and the association of the groups of channels in the L0 layer and the groups of channels in the L1 layer to the chips may be performed, for example, by an operator or by the operation device 1 or other devices.

In this example, it is assumed that the channels in the L0 layer are divided into the group A and the group B, and the channels in the L1 layer are also divided into the group A and the group B, as illustrated in FIG. 3. Furthermore, it is assumed that the group A of the L0 layer and the group A of the L1 layer are associated with the chip 10, and that the group B of the L0 layer and the group B of the L1 layer are associated with the chip 20.

In addition, an edge is set between channels that belong to the corresponding groups. In other words, it is determined that an edge is set between the channels that belong to the corresponding groups.

Furthermore, the setting of edges between channels belonging to non-corresponding groups is performed under a certain restriction. In this example, it is assumed that this restriction is the restriction that no edge is set between channels that belong to non-corresponding groups. Therefore, it is determined that no edges are set between channels that belong to non-corresponding groups. The setting of edges between channels belonging to non-corresponding groups may be performed, for example, by the operator or by the operation device 1 or other devices, as in the above case.

After grouping of channels, the association of the groups of channels in the L0 layer and the groups of channels in the L1 layer and the chips, the edges between the channels belonging to the corresponding groups, and the edges between the channels belonging to the non-corresponding groups are determined, weights are determined by the learning for each edge set between the L0 layer and the L1 layer according to such conditions.

The determined weights are then allocated to the weight storage units 11, 21 in respective chips, and the weight storage units 11, 21 store the allocated weights.

The weight storage unit 11 in the chip 10 is allocated the weights defined for the edges between the channels belonging to the corresponding groups (in this example, the group A shown in FIGS. 3 and 4) corresponding to the chip 10. In this example, the weight storage unit 11 stores the weight W₁₁ defined for the edge between the channel CH1 belonging to the group A of the L0 layer and the channel CH1 belonging to the group A of the L1 layer, and the weight W₁₂ defined for the edge between the channel CH1 belonging to the group A of the L0 layer and the channel CH2 belonging to the group A of the L1 layer.

The weight storage unit 21 in the chip 20 is allocated the weights defined for the edges between the channels belonging to the corresponding groups (in this example, the group B shown in FIGS. 3 and 4) corresponding to the chip 20. In this example, the weight storage unit 21 stores the weight W₂₃ defined for the edge between the channel CH2 belonging to the group B of the L0 layer and the channel CH3 belonging to the group B of the L1 layer.

The entities that perform the process of learning the weights and the process of allocating the weights to the chips are, for example, the operation circuits 12, 22 in each chips 10, 20. In this case, the operation circuits 12, 22 in each chip 10, 20 can be referred to as learning means. Alternatively, a device (for example, a computer) external to the operation device 1 may be the entity that performs the process of learning the weights and the process of allocating the weights to the chips. In this case, the external device is referred to as learning means.

The operation circuits 12, 22 in each chip 10, 20 calculate a set of values of each layer of the neural network based on a set of values of the previous layer and the weights. An example of values to an input layer is respective pixel values of an image. The operation circuit 12 calculates the feature value group C₀₁ corresponding to the channel CH1 of the L0 layer as a set of values of the L0 layer. The operation circuit 22 calculates the feature value group C₀₂ corresponding to the channel CH2 of the L0 layer as a set of values of the L0 layer.

Then, the operation circuit 12 in the chip 10 calculates the feature value group C₁₁ corresponding to the channel CH1 of the L1 layer using the feature value group C₀₁ and the weight W₁₁. Similarly, the operation circuit 12 calculates the feature value group C₁₂ corresponding to the channel CH2 of the L1 layer using the feature value group C₀₁ and the weight W₁₂. When calculating the feature value groups C₁₁ and C₁₂, the data held by the chip 20 is not used. Therefore, no data communication between the chip 10 and the chip 20 is required when the operation circuit 12 calculates the feature value groups C₁₁ and C₁₂.

The operation circuit 22 in the chip 20 calculates the feature value group C₁₃ corresponding to the channel CH3 of the L1 layer using the feature value group C₀₂ and the weights W₂₃. When calculating the feature value group C₁₃, the data held by the chip 10 is not used. Therefore, data communication between the chip 10 and the chip 20 is not necessary even when the operation circuit 22 calculates the feature value group C₁₃.

The operation circuits 12, 22 sequentially calculate a set of values for each layer after the L1 layer.

In the above example, the case where the restriction on setting edges between channels belonging to non-corresponding groups is the restriction that no edges are set between channels belonging to non-corresponding groups is shown. In the following explanation, the case where the restriction on setting edges between channels belonging to non-corresponding groups is the restriction on setting edges only for some pairs of channels belonging to non-corresponding groups will be explained as an example, referring to FIG. 5 and FIG. 6.

In this example, it is assumed that it is determined to set an edge only on a pair of CH1 of the L0 layer and CH3 of the L1 layer among the pairs of channels belonging to non-corresponding groups. This setting may be made by the operator, for example, or by the operation device 1 or other devices, as in the above case.

The other matters to be determined before learning are the same as in the above case. After each matter is determined, weights are determined by learning for each edge between the L0 layer and the L1 layer according to such conditions. The determined weights are then allocated to the weight storage units 11, 21 of the respective chips, and the weight storage units 11, 21 store the allocated weights. Since the entities that perform the process of learning weights and allocating weights to chips have already explained, explanations are omitted here.

The weight storage unit 11 of chip 10 stores weights W₁₁ and W₁₂ in the same way as described above. The weight storage unit 21 in chip 20 stores the weights W₂₃ in the same way as described above.

Further, in this example, the weight storage unit 21 in the chip 20 is allocated the weight W₁₃ (refer to FIG. 5 and FIG. 6) defined for the edge between the channel CH1 belonging to the group A of the L0 layer and the channel CH3 belonging to the group B of the L1 layer, and the weight storage unit 21 in the chip 20 also stores the weight W₁₃.

As in the above case, the operation circuits 12, 22 of respective chips 10, 20 calculate a set of values of each layer of the neural network based on the set of values of the previous layer and the weights. The operation circuit 12 calculates the feature value group C₀₁ corresponding to the channel CH1 of the L0 layer as the set of values of the L0 layer. The operation circuit 22 calculates the feature value group C₀₂ corresponding to the channel CH2 of the L0 layer as the set of values of the L0 layer.

The operation circuit 12 in the chip 10 calculates the feature value group C₁₁ corresponding to the channel CH1 of the L1 layer and the feature value group C₁₂ corresponding to the channel CH2 of the L1 layer. This process is similar to the process described above, and no data communication between the chip 10 and the chip 20 is required when the operation circuit 12 calculates the feature value groups C₁₁ and C₁₂.

The operation circuit 22 in the chip 20 calculates the feature value group C₁₃ corresponding to the channel CH3 of the L1 layer using the feature value group C₀₁, the weight W₁₃, the feature value group C₀₂, and the weight W₂₃. The channel CH3 of the L1 layer belongs to the group B. Then, when calculating the feature value group C₁₃, the feature value group C₀₁ corresponding to the channel CH1 belonging to the group A of the L0 layer that does not correspond to the group B of the L1 layer is used. The chip corresponding to the group A of the L0 layer is the chip 10, and the feature value group C₀₁ is held in the chip 10. Therefore, the operation circuit 22 in the chip 20 obtains the feature value group C₀₁ held in the operation circuit 12 in the chip 10. For example, the operation circuit 22 requests the feature value group C₀₁ to the chip 10 through the communication circuit 23. When the operation circuit 12 in the chip 10 receives the request through the communication circuit 13, it transmits the feature value group C₀₁ to the chip 20 through the communication circuit 13. The operation circuit 22 can receive the feature value group C₀₁ through the communication circuit 23.

After obtaining the feature value group C₀₁, the operation circuit 22 calculates the feature value group C₁₃ using the feature value group C₀₁, the weight W₁₃, the feature value group C₀₂ and the weight W₂₃. In this way, when calculating the feature value group C₁₃, the feature value group C₀₁ is transmitted and received between the chip 10 and the chip 20. However, the amount of data communication is less than the case where edges are set for all pairs of channels belonging to non-corresponding groups. Therefore, the amount of data communication between chips can be reduced in this example as well.

The operation circuits 12, 22 sequentially calculate a set of values for each layer after the L1 layer.

The above example shows a case where the weight W₁₃ is allocated to the weight storage unit 21 in the chip 20. However, the weight W₁₃ may be allocated to the weight storage unit 11 in the chip 10, and the weight storage unit 11 may store the weight W₁₃. In this case, the operation circuit 12 in the chip 10 may calculate values for calculating the feature value group C₁₃ using the feature value group C₀₁ and the weight W₁₃, and the operation circuit 22 in the chip 20 may obtain the calculation result from the chip 10. Then, the operation circuit 22 may calculate the feature value group C₁₃ using the calculation result, the feature value group C₀₂ and the weight W₂₃.

In the above example, if the absolute value of the value of the weight corresponding to the edge defined for a pair of channels belonging to non-corresponding groups is less than or equal to a predetermined threshold value, the edge is assumed not to exist, and the weight may not be allocated either. For example, in the above example, if the absolute value of W₁₃ is less than or equal to the threshold value, the edge between CH1 of the L0 layer and CH3 of the L1 layer is considered to not exist, and the allocation of W₁₃ to the chip may not be performed. In this case, the operation circuit 22 in the chip 20 may calculate the feature value group C₁₃ using the feature value group C₀₂ and the weight W₂₃. Accordingly, the amount of data communication between chips can be further reduced. In this case, the amount of data communication between chips becomes zero.

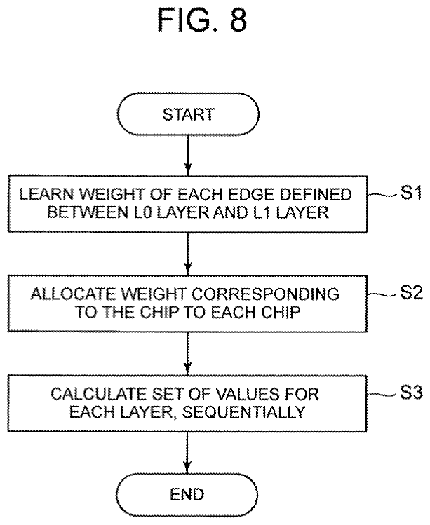

FIG. 8 is a flowchart shows an example of a process from learning the weights to a calculation process in this example embodiment. Regarding the matters already explained, explanations are omitted.

First, the weights of respective edges defined between the L0 layer and the L1 layer is learned (Step S1). Since the matters to be determined before learning have already been explained, they will not be explained here. In Step S1, the weights of respective edges are learned based on the determined matters.

Next, weights corresponding to the chip are allocated to each chip 10, 20 (Step S2). The weight storage units 11, 21 in the chips 10, 20 store the allocated weights.

Then, when the data (for example, an image) that will be the input layer is input, the operation circuits 12, 22 in respective chips 10, 20 calculate a set of values for each layer, sequentially (Step S3). The process of calculating the feature value group of the L1 layer from the feature value group of the L0 layer has already been explained, so explanations are omitted here.

According to this example embodiment, the setting of edges between channels belonging to non-corresponding groups is performed under a predetermined restriction. Then, the weights of respective edges are learned to satisfy the edge settings so defined. The chip 10 is associated with the group A of the L0 and L1 layers, and the chip 20 is associated with the group B of the L0 and L1 layers. Then, a weight is allocated to each chip corresponding to the chip.

Therefore, the amount of data communication between the chip 10 and the chip 20 can be reduced when each chip 10, 20 calculates the feature value group of the L1 layer using the feature value group of the L0 layer. Further, since the amount of data communication between the chips 10, 20 can be reduced, it is also possible to achieve higher speed in the calculation of the neural network.

### Example Embodiment 2

In the second example embodiment of the present invention, the channels are divided into the same number of groups in each of the L0 and L1 layers. This number of groups is the number of chips included in the operation device of the present invention. That is, in each of the L0 and L1 layers, the channels are divided into the same number of groups as it of the chips. Furthermore, the groups of channels in the L0 layer and the groups of channels in the L1 layer are associated with the chips. This point is the same as in the first example embodiment. For the sake of simplicity, the case where the number of chips is two will be used as an example also in this example embodiment. The configuration of the operation device of the second example embodiment can be represented as shown in FIG. 7, as in the first example embodiment, and will be explained with reference to FIG. 7 as appropriate. However, weights other than those shown in FIG. 7 can also be allocated to the weight storage units 11, 21.

In the second example embodiment, an edge is set between each channel in the L1 layer and each channel in the L0 layer. In this state, the weight of each edge is determined by learning. In other words, under the condition that in each of the L0 and L1 layers, the channels are divided into the same number of groups as it of the chips, the groups of channels in the L0 layer, the groups of channels in the L1 layer, and the chips are associated, and an edge between each channel in the L1 layer and each channel in the L0 layer is set, weights of respective edges are determined by learning.

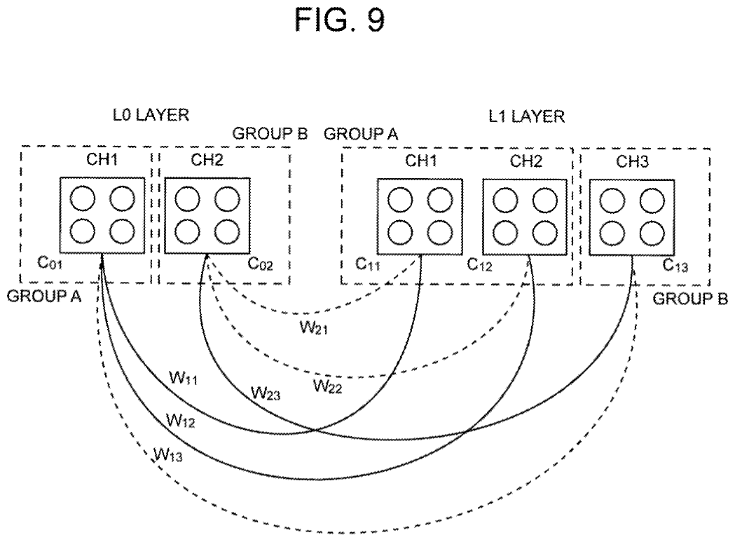

FIG. 9 is a schematic diagram showing an example of a case where channels are divided into groups on condition that the number of the groups of the L0 layer is the same as it of the L1 layer in the second example embodiment. Regarding the matters explained with reference to FIG. 3, explains are omitted. However, the grouping of channels in the L0 and L1 layers and the association of the groups of channels in the L0 layer and the groups of channels in the L1 layer and chips are not limited to the example shown in FIG. 9. In the second example embodiment, an edge is set between each channel in the L1 layer and each channel in the L0 layer. Therefore, not only edges are set between channels that belong to corresponding groups, but also between channels that belong to non-corresponding groups. In FIG. 9, the edges set between the channels belonging to the non-corresponding groups are shown as dashed lines.

The learning means (which may be the operation circuits 12, 22 in each chip 10, 20, or a device external (for example, a computer) to the operation device) learns the weight of each edge shown in FIG. 9 under the state illustrated in FIG. 9.

There is no particular condition for learning the weights of the edges (edges shown by solid lines in FIG. 9) set between channels belonging to corresponding groups. However, as for learning the weights of the edges (edges shown by dashed lines in FIG. 9) set between channels belonging to non-corresponding groups, the learning means learns the weights under the condition that the weights are learned so that the weights become to be 0 or close to 0 as possible. In the example shown in FIG. 9, W₁₃, W₂₁, and W₂₂ are learned to be as 0 or close to 0 as possible. However, the result of learning does not necessarily mean that those weights will be 0 or close to 0.

Hereinafter, the weight determined for the edge set between the channels belonging to the corresponding groups is referred to as the first weight. In the example shown in FIG. 9, W₁₁, W₁₂, and W₂₃ correspond to the first weights. The weight determined for the edge set between channels belonging to non-corresponding groups and which is equal to or more than a predetermined threshold are referred to as the second weight.

The learning means removes edges when the weights defined for the edges set between the channels belonging to the non-corresponding groups are less than a predetermined threshold. In this example, for the sake of simplicity, it is assumed that the weights W₂₁ and W₂₂ are less than the threshold value, and that the two edges for which the weights W₂₁ and W₂₂ are set have been removed. Depending on the learning result, it is possible that the weights W₂₁ and W₂₂ are not less than the threshold values, but the operation as the second example embodiment of the invention remains the same. In this example, if the weights W₂₁, W₂₂, and W₁₃ are all less than the threshold value, then all edges set between channels belonging to non-corresponding groups will be removed.

The learning means stores the first weight in the weight storage unit in the chip corresponding to the group to which the channel connected by the edge for which the weight is determined belongs. For example, since the group A to which the channel connected by the edge for which the weight W₁₁ is determined belongs corresponds to chip 10 (refer to FIG. 7), the learning means stores the weight W₁₁ in the weight storage unit 11 in the chip 10. The learning means also stores the weights W₁₂ in the weight storage unit 11 in the chip 10 in the same way. For example, the group B to which the channel connected by the edge with the weight W₂₃ belongs corresponds to the chip 20 (refer to FIG. 7), so the learning means stores the weight W₂₃ in the weight storage unit 21 in the chip 20.

The learning means stores the second weight in the weight storage unit in the chip corresponding to the group to which the L1 layer channel belongs among the channels connected by the edge for which the weight is determined. In this example, the weight W₁₃ is equal to or more than or equal to the threshold and corresponds to the second weight. The weight W₁₃ is a weight determined for the edge connecting the channel CH1 of the L0 layer and the channel CH3 of the L1 layer (refer to FIG. 9). In addition, the channel CH3 of the L1 layer belongs to the group B of the L1 layer, which corresponds to the chip 20. Therefore, the learning means stores the weights W₁₃ in the weight storage unit 21 in the chip 20. As a result, weights W₁₁ and W₁₂ have been stored in the weight storage unit 11, and weights W₂₃ and W₁₃ have been stored in the weight storage unit 21, although the illustration of “W₁₃” is omitted in FIG. 7.

The operation in which the operation device 1 (refer to FIG. 7) calculates the feature value groups C₁₁, C₁₂, and C₁₃ of the L1 layer after that is the same as the operation in the first example embodiment. In this example, values used to calculate each feature value group of the L1 layer can be represented in the same way as in FIG. 6 shown in the first example embodiment. The following explanation will refer to FIG. 6 as appropriate.

The operation device 1 executes an operation to calculate the feature value groups C₁₁ and C₁₂ on the chip 10 corresponding to group A, and an operation to calculate the feature value group C₁₃ on the chip 20 corresponding to group B.

The operation circuits 12, 22 in respective chips 10, 20 calculate the set of values of respective layers of the neural network based on the set of values of the previous layer and the weights. An example of a value to an input layer is an individual pixel value of an image. The operation circuit 12 calculates the feature value group C₀₁ corresponding to the channel CH1 of the L0 layer as a set of values of the L0 layer. The operation circuit 22 calculates the feature value group C₀₂ corresponding to the channel CH2 of the L0 layer as a set of values of the L0 layer.

Then, the operation circuit 12 in the chip 10 calculates the feature value group C₁₁ corresponding to the channel CH1 of the L1 layer using the feature value group C₀₁ and the weight W₁₁ (refer to FIG. 6). Similarly, the operation circuit 12 calculates the feature value group C₁₂ corresponding to the channel CH2 of the L1 layer using the feature value group C₀₁ and the weight W₁₂ (refer to FIG. 6). When calculating the feature value groups C₁₁ and C₁₂, the data held by the chip 20 is not used. Therefore, no data communication between the chip 10 and the chip 20 is required when the operation circuit 12 calculates the feature value groups C₁₁ and C₁₂.

The operation circuit 22 in the chip 20 calculates the feature value group C₁₃ corresponding to the channel CH3 of the L1 layer using the feature value group C₀₁, the weight W₁₃, the feature value group C₀₂ and the weight W₂₃. Here, the feature value group C₀₁ is held in the chip 10. Therefore, the operation circuit 22 in the chip 20 obtains the feature value group C₀₁ held in the operation circuit 22 in the chip 10. For example, the operation circuit 22 requests the feature value group C₀₁ to the chip 10 through the communication circuit 23. When the operation circuit 12 in the chip 10 receives the request through the communication circuit 13, it transmits the feature value group C₀₁ to the chip 20 through the communication circuit 13. The operation circuit 22 can receive the feature value group C₀₁ through the communication circuit 23. After obtaining the feature value group C₀₁, the operation circuit 22 calculates the feature value group C₁₃ using the feature value group C₀₁, the weight W₁₃, the feature value group C₀₂, and the weight W₂₃.

Thus, when calculating the feature value group C₁₃, the feature value group C₀₁ is transmitted and received between the chip 10 and the chip 20. However, in this example embodiment, the weights of the edges set between the channels belonging to the non-corresponding groups are learned to be 0 or close to 0 as much as possible, and the edges set between the channels belonging to the non-corresponding groups whose determined weights are less than the threshold are removed. Therefore, in the second example embodiment, the operation of the neural network can be executed while the amount of data communication between chips can also be reduced.

The operation circuits 12, 22 sequentially calculate a set of values for each layer after the L1 layer.

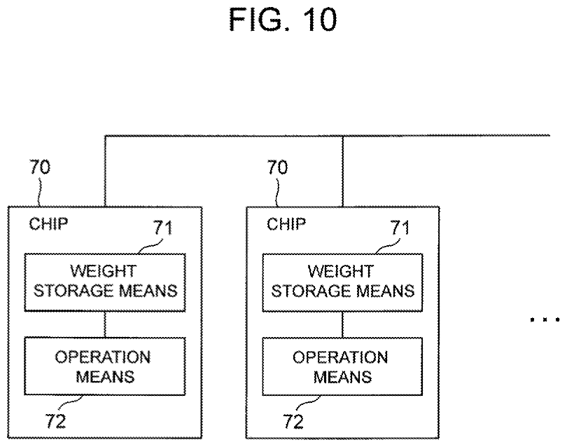

Next, an overview of the present invention will be explained. FIG. 10 is a block diagram showing an overview of the operation device of the present invention. The operation device of the present invention has a plurality of chips 70 (for example, chips 10, 20).

Each chip 70 comprises weight storage means 71 (for example, weight storage units 11, 21) for storing weights for each edge determined by learning under the condition that channels in a first layer (for example, the L1 layer) that is a layer in a neural network and channels in a 0th layer (for example, the L0 layer) that is a previous layer to the first layer are divided into groups whose number is equal to the number of the chips, respectively, the groups of the channels in the first layer and the groups of the channels in the 0th layer and the chips are associated, an edge is set between the channels belonging to corresponding groups, an edge is set between the channels belonging to non-corresponding groups under a restrict.

The weight storage means 71 in each chip 70 stores the weights determined for the edge between the channels, each of which corresponds to each chip including the weight storage means, belonging to corresponding groups.

In addition, each chip comprises operation means 72 (for example, operation circuits 12, 22) for calculating a set of values for the channel that belongs to the group in the first layer corresponding to the group in the 0th layer, based on the weight stored in the weight storage means in the chip, and a set of values for the channel that belongs to the group in the 0th layer corresponding to the chip.

With such a configuration, the amount of data communication between chips can be reduced while the neural network operations are performed on multiple chips.

The weight storage means in each chip may store the weight for each edge determined under the condition that the edges between channels that belong to non-corresponding groups are set only for some pairs among pairs of channels that belong to the non-corresponding groups, and when calculating the set of values for the channel that belongs to the group corresponding to the chip in the first layer, if there is the channel belonging to the group that does not correspond to the group and for which the edge connected to the channel belonging to the group is set, the operation means in each chip obtains the set of values for the channel belonging to the group that does not correspond to the group from another chip corresponding to the group that does not correspond to the group, and calculates the set of values for the channel that belongs to the group in the first layer using obtained set of values.

The weight storage means in each chip may store the weight for each edge determined under the condition that the edge is not set between the channels that belong to non-corresponding groups.

The operation means in each chip may determine the weight by learning.

While the present invention has been described with reference to the example embodiments, the present invention is not limited to the aforementioned example embodiments.

Various changes understandable to those skilled in the art within the scope of the present invention can be made to the structures and details of the present invention.

### INDUSTRIAL APPLICABILITY

The present invention is suitably applied to an operation device that performs neural network operations.

### REFERENCE SIGNS LIST

1 Operation device
10, 20 Chip
11, 21 Weight storage unit
12, 22 Operation circuit
13, 23 Communication circuit

What is claimed is:

1. An operation device including a plurality of chips,
wherein
each chip comprises a weight storage unit for storing weights for each edge determined by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between the channels belonging to corresponding groups, an edge is set between the channels belonging to non-corresponding groups under a restriction,
wherein the weight storage unit in each chip stores the weights determined for the edge between the channels, each of which corresponds to each chip including the weight storage unit belonging to corresponding groups, and
wherein each chip further comprises an operation unit for calculating a set of values for the channel that belongs to the group in the first layer corresponding to the group in the 0th layer, based on the weight stored in the weight storage unit in the chip, and a set of values for the channel that belongs to the group in the 0th layer corresponding to the chip.

2. The operation device according to claim 1,
wherein the weight storage unit in each chip stores the weight for each edge determined under the condition that the edges between channels that belong to non-corresponding groups are set only for some pairs among pairs of channels that belong to the non-corresponding groups, and
wherein when calculating the set of values for the channel that belongs to the group corresponding to the chip in the first layer, if there is the channel belonging to the group that does not correspond to the group corresponding to the chip and for which the edge connected to the channel belonging to the group corresponding to the chip is set, the operation unit in each chip obtains the set of values for the channel belonging to the group that does not correspond to the group corresponding to the chip from another chip corresponding to the group that does not correspond to the group corresponding to the chip, and calculates the set of values for the channel that belongs to the group in the first layer using obtained set of values.

3. The operation device according to claim 1,
wherein the weight storage unit in each chip stores the weight for each edge determined under the condition that the edge is not set between the channels that belong to non-corresponding groups.

4. An operation device including a plurality of chips,
wherein
each chip comprises a weight storage unit for storing weights for each edge determined by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between each channel in the first layer and each channel in the 0th layer, the weight between the channels that belong to non-corresponding groups is learned so that the weight becomes to be 0 or close to 0 as possible,
wherein the weight storage unit in each chip stores a first weight determined for the edge between the channels, each of which corresponds to each chip including the weight storage unit belonging to corresponding groups, and a second weight for the edge between the channel, belonging to the group in the first layer, corresponding to the chip and the channel, belonging to the group in the 0th layer, non-corresponding to the chip, wherein the second weight is equal to or more than a predetermined threshold, and
wherein each chip further comprises an operation unit for
calculating a set of values for the channel that belongs to the group in the first layer corresponding to the group in the 0th layer, based on the first weight and a set of values for the channel that belongs to the group in the 0th layer corresponding to the chip, and
when calculating the set of values for the channel that belongs to the group corresponding to the chip in the first layer, if there is the channel belonging to the group that does not correspond to the group corresponding to the chip and for which the edge connected to the channel belonging to the group corresponding to the chip is set wherein the second weight is determined for the edge, obtaining the set of values for the channel belonging to the group that does not correspond to the group corresponding to the chip from another chip that corresponds to the group that does not correspond to the group corresponding to the chip, and calculating the set of values for the channel that belongs to the group corresponding to the chip in the first layer using obtained set of values and the second weight.

5. An operation allocation method for allocating operations to a plurality of chips included in an operation device, comprising:
determining weights for each edge by learning under the condition that channels in a first layer that is a layer in a neural network and channels in a 0th layer that is a previous layer to the first layer are divided into groups whose number is equal to the number of the chips, respectively, the groups of the channels in the first layer and the groups of the channels in the 0th layer and the chips are associated, an edge is set between the channels belonging to corresponding groups, an edge is set between the channels belonging to non-corresponding groups under a restriction, and
allocating the weight determined for the edge between the channels, each of which corresponds to each chip, belonging to corresponding groups, to each chip,
wherein a set of values for the channel that belongs to the group in the first layer corresponding to the group in the 0th layer is calculated by each chip, based on the weight allocated to the chip, and a set of values for the channel that belongs to the group in the 0th layer corresponding to the chip.

6. The operation allocation method according to claim 5, wherein
the weight for each edge is determined by learning under the condition that the edges between channels that belong to non-corresponding groups are set only for some pairs among pairs of channels that belong to the non-corresponding groups, and
when calculating the set of values for the channel that belongs to the group corresponding to the chip in the first layer, if there is the channel belonging to the group that does not correspond to the group corresponding to the chip and for which the edge connected to the channel belonging to the group corresponding to the chip is set, the set of values for the channel belonging to the group that does not correspond to the group corresponding to the chip is obtained by each chip from another chip corresponding to the group that does not correspond to the group corresponding to the chip, and the set of values for the channel that belongs to the group in the first layer is calculated by each chip using obtained set of values.

7. The operation allocation method according to claim 5, wherein
the weight for each edge is determined by learning under the condition that the edge is not set between the channels that belong to non-corresponding groups.

8. (canceled)
